(19) United States
(12) Patent Application Publication
(10) Pub. No.: US 2025/0267386 A1
(43) Pub. Date: Aug. 21, 2025

(54) BLUETOOTH EARPHONE CABIN WITH CAMERA

(71) Applicant: JIN GE, Zhangjiajie (CN)

(72) Inventor: BO CHEN, Zhangjiajie (CN)

(21) Appl. No.: 18/936,326

(22) Filed: Nov. 4, 2024

(30) Foreign Application Priority Data
Feb. 20, 2024 (CN) 202410186472.4

(51) Int. Cl. H04R 1/02; H04N 23/51; H04N 23/57; H04N 23/62; H04R 1/10

(52) U.S. Cl. CPC H04R 1/028; H04N 23/51; H04N 23/57; H04N 23/62; H04R 1/1025; H04R 2420/07; H04R 2499/11

(57) ABSTRACT

Disclosed is a Bluetooth earphone cabin with a camera, including a shell. An earphone placement cavity and an electronic element cavity are arranged inside the shell, where a battery and a circuit board that are electrically connected to each other are arranged inside the electronic element cavity. A display screen, a camera and a shutter key are arranged on the shell, where the display screen, the camera and the shutter key are all electrically connected to the circuit board. A memory card interface and a memory card reading circuit are arranged on the circuit board.

### CROSS-REFERENCE TO RELATED APPLICATIONS

This application claims priority to Chinese Patent Application No. 202410186472.4, filed on Feb. 20, 2024, which is hereby incorporated by reference in its entirety.

### TECHNICAL FIELD

The present disclosure relates to the technical field of Bluetooth earphones, and particularly relates to a Bluetooth earphone cabin with a camera.

### BACKGROUND

A Bluetooth earphone cabin, also known as an earphone case, is a device used to store an earphone or a Bluetooth earphone and is highly favored by consumers.

However, an ordinary Bluetooth earphone cabin is only used to store an earphone and charge the earphone, without other functions such as photo taking and shooting, audio playback, video lyric display, and file storage, thereby limiting its usage scenarios and requiring further improvement.

### SUMMARY

An objective of the present disclosure is to provide a Bluetooth earphone cabin with a camera, so as to solve the problem of the prior art that a Bluetooth earphone with an integrated shooting function is not provided with a display screen, thus making it inconvenient to give timely feedback on the shooting effect and having poor interactivity.

The present disclosure is implemented as follows: A Bluetooth earphone cabin with a camera, includes a shell, where an earphone placement cavity and an electronic element cavity are arranged inside the shell, and a battery and a circuit board that are electrically connected to each other are arranged inside the electronic element cavity; a display screen, a camera and a shutter key are arranged on the shell, where the display screen, the camera and the shutter key are all electrically connected to the circuit board; a memory card interface and a memory card reading circuit are arranged on the circuit board, a memory card insertion port leading to the electronic element cavity is arranged on the body wall of the shell, and the memory card insertion port is arranged in a manner of being aligned with the memory card interface on the circuit board.

Further, a charging plug is arranged on the circuit board, a charging socket leading to the electronic element cavity is arranged on a body wall of the shell, and the charging plug is located in the charging socket; and an indicator lamp is further arranged on the shell, and the indicator lamp and the camera are located on a same side of the shell.

Further, an opening is formed at an upper end of the earphone placement cavity, and a cover plate is damping hinged at the upper end of the earphone placement cavity; an embedded groove is formed on an outer end face of the cover plate, the display screen is arranged in the embedded groove, and the display screen is a touch screen; and an earphone placement slot is formed at a bottom of the earphone placement cavity, and charging pins for charging the Bluetooth earphone are arranged on a bottom wall of the earphone placement slot, where the charging pins are electrically connected to the circuit board and the battery.

Further, a fixed hinge shaft seat is arranged on a side of the opening on the upper end of the earphone placement cavity, and a buckle opening structure is arranged on the other side of the opening on the upper end of the earphone placement cavity.

Further, a first clamping structure is arranged on a wall of the embedded groove, a second clamping structure that matches and corresponds to the first clamping structure of the embedded groove in position is arranged on the display screen, and the display screen is in clamped connection with the cover plate.

Further, the first clamping structure and the second clamping structure are a clamping groove structure and a clamping block structure respectively. Alternatively, the first clamping structure and the second clamping structure are a clamping block structure and a clamping groove structure respectively.

Further, the display screen is provided with a data communication insertion interface, and a data communication plug electrically connected to the circuit board is arranged in the embedded groove. When the display screen is clamped into the embedded groove, the data communication plug is inserted into the data communication insertion interface of the display screen.

Further, a Bluetooth chip is further arranged on the circuit board, and through the Bluetooth chip, the circuit board is in communication connection with an electronic device with a Bluetooth chip.

Further, a microphone is further arranged in the electronic element cavity, and the microphone is electrically connected to the circuit board.

Further, a speaker is further arranged in the electronic element cavity, an audio decoding chip is arranged on the circuit board, and the speaker is electrically connected to the circuit board through the audio decoding chip.

Compared with the prior art, the present disclosure features the following beneficial effects:
1. In the present disclosure, the display screen and the camera that are in communication connection with the circuit board are arranged. Pictures, videos, and so on taken by the camera can be viewed through the display screen, which facilitates users' understanding of shooting effects in a timely manner, thus enhancing interactivity.
2. Through the display screen, a user can accurately know a remaining capacity of the battery, so that the user can charge the battery in a timely manner. The display screen can be a touch screen. Through the display screen, the user can perform operations such as file switching, so that human-computer interactions become more efficient.
3. The display screen can be embedded on the cover plate and rotate with the cover

plate, which effectively enhances the flexibility of the display screen, makes the use more convenient, reduces an overall thickness of the earphone cabin, facilitates the design of the internal earphone placement cavity, and increases a volume ratio of the battery. A larger-capacity battery can be arranged to effectively prolong the service life.
4. The cover plate is damping hinged, so that the cover plate and the display screen can be opened at any angle without shaking.
5. The present disclosure is further provided with the microphone and the speaker that are electrically connected to the circuit board. The microphone is capable of acquiring audio signals, so that the present disclosure can be used as a voice recorder, and music playback can be achieved through the speaker.
6. A Bluetooth chip is further arranged on the circuit board of the present disclosure, and the circuit board, through the Bluetooth chip, can be in communication connection with an electronic device with a Bluetooth chip, such as a mobile phone, a Bluetooth earphone 5, and the like. After the present disclosure is connected to a mobile phone, the user can view photos or videos taken through a compatible APP. After the present disclosure is connected to the Bluetooth earphone, audio playback can be achieved through the Bluetooth earphone, which reduces the user's reliance on the mobile phone for audio playback, thereby ensuring the mobile phone's battery life.
7. The present disclosure with a simple structure is compact and portable, and serves multiple purposes, thus effectively enriching usage scenarios.

### BRIEF DESCRIPTION OF DRAWINGS

FIG. 1 is a schematic diagram of a first view of a three-dimensional structure of the present disclosure.

FIG. 2 is a schematic diagram of a second view of a three-dimensional structure of the present disclosure.

FIG. 3 is a schematic diagram of a three-dimensional structure of the present disclosure when a cover plate is closed.

FIG. 4 is a schematic diagram of a three-dimensional structure of the present disclosure when a cover plate is opened.

FIG. 5 is a structural schematic diagram of a cover plate and a display screen of the present disclosure.

FIG. 6 is a block diagram of an electronic control structure of the present disclosure.

In the figures: 1, shell; 101, earphone placement cavity; 102, charging socket; 103, memory card insertion port; 104, buckle opening structure; 2, cover plate; 201, embedded groove; 3, display screen; 4, fixed hinge shaft seat; 5, Bluetooth earphone; 6, camera; 7, shutter key; and 8, indicator lamp.

### DESCRIPTION OF EMBODIMENTS

In the present disclosure, unless otherwise explicitly specified and defined, the terms “mounting”, “connecting”, “connection”, “fixing”, etc. should be understood in a broad sense, for example, they may be a fixed connection, a detachable connection, or an integrated connection; may be a mechanical connection, or an electrical connection; may be a direct connection, or an indirect connection via an intermediate medium; and may be communication inside two elements, or an interactive relation between two elements. For those of ordinary skill in the art, the specific meanings of the above terms in the present disclosure may be understood according to specific circumstances.

The present disclosure will be further described below with reference to the accompanying drawings and the specific embodiments.

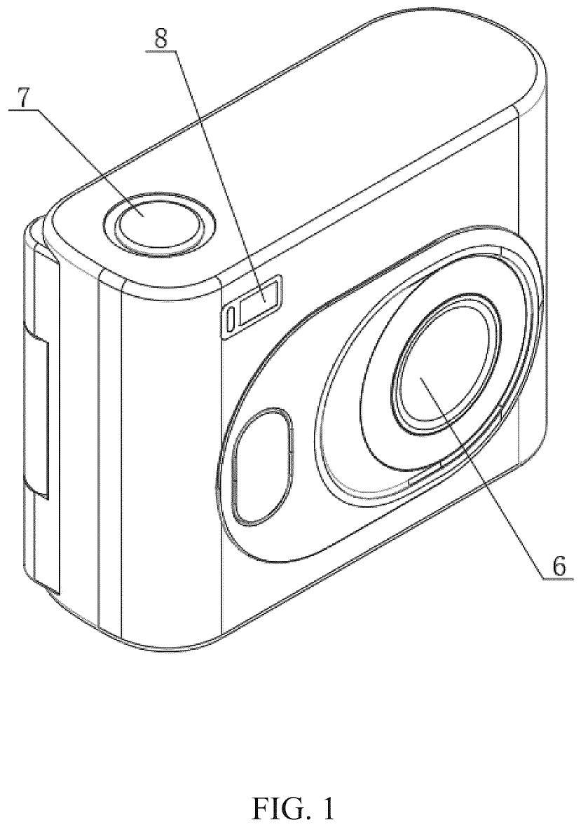

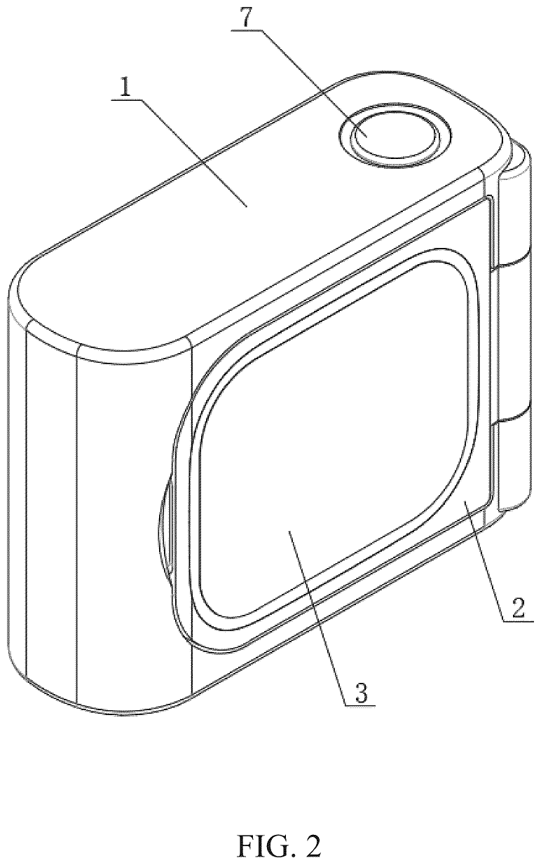

A Bluetooth earphone cabin with a camera, as shown in FIGS. 1, 2, 3 and 6, includes a shell 1, an electronic element cavity is arranged inside the shell 1, a battery and a circuit board that are electrically connected to each other are arranged inside the electronic element cavity, a charging plug is arranged on the circuit board, and the charging plug is configured for charging the battery. A charging socket 102 leading to the electronic element cavity is arranged on a body wall of the shell 1, and the charging plug is located in the charging socket 102. A display screen 3, a camera 6 and a shutter key 7 are arranged on the shell 1, where the display screen 3, the camera 6 and the shutter key 7 are all electrically connected to the circuit board. A memory card interface and a memory card reading circuit are arranged on the circuit board, a memory card insertion port 103 leading to the electronic element cavity is arranged on the body wall of the shell 1, and the memory card insertion port 103 is arranged in a manner of being aligned with the memory card interface on the circuit board. The memory card can be inserted into the memory card interface on the circuit board through the memory card insertion port 103, and can store pictures, videos, and so on taken by the camera 6, as well as music files, text files, and the like downloaded from the Internet. Pictures, videos, and so on taken by the camera 6 can be viewed through the display screen 3, which facilitates users' understanding of shooting effects in a timely manner, thus enhancing interactivity. Through the display screen 3, a user can accurately know a remaining capacity of the battery, so that the user can charge the battery in a timely manner. The display screen 3 is a touch screen. Through the display screen 3, the user can perform operations such as file switching, so that human-computer interactions become more efficient.

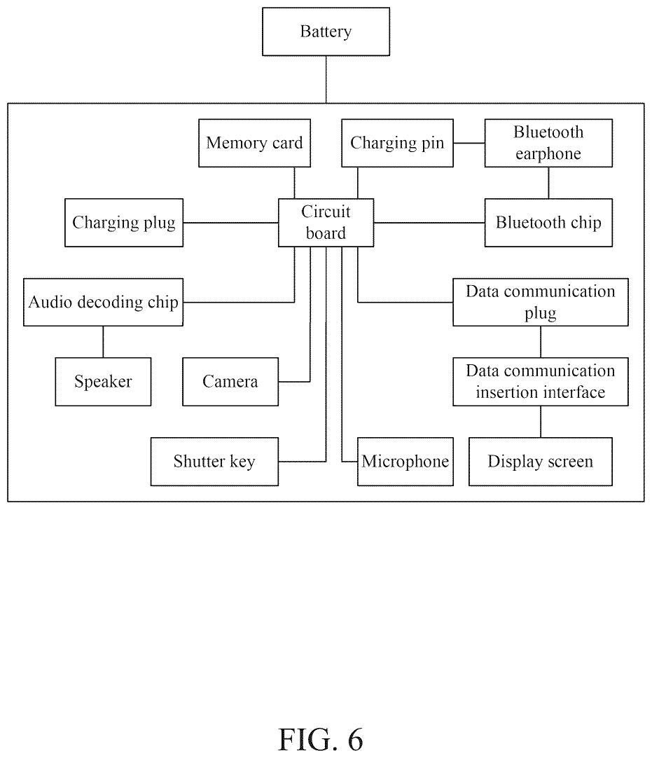

As shown in FIGS. 1 and 6, an indicator lamp 8 is further arranged on the shell 1, and the indicator lamp 8 and the camera 6 are located on a same side of the shell 1. The indicator lamp 8 can be used as an illuminating lamp or a flash lamp, which enhances the functionality of the present disclosure and enables the camera 6 to take photos normally even under low light conditions. A microphone and a speaker are further arranged in the electronic element cavity, where the microphone is electrically connected to the circuit board. An audio decoding chip is arranged on the circuit board, and the speaker is electrically connected to the circuit board through the audio decoding chip. The microphone is capable of acquiring audio signals, so that the present disclosure can be used as a voice recorder, and music playback can be achieved through the speaker. Further, the display screen 3 is capable of displaying song lyrics and other audio information. A Bluetooth chip is further arranged on the circuit board, and the circuit board, through the Bluetooth chip, can be in communication connection with an electronic device with a Bluetooth chip, such as a mobile phone, a Bluetooth earphone 5, and the like. After the present disclosure is connected to a mobile phone, the user can view photos or videos taken through a compatible APP. After the present disclosure is connected to the Bluetooth earphone 5, audio playback can be achieved through the Bluetooth earphone 5, which reduces the user's reliance on the mobile phone for audio playback, thereby ensuring the mobile phone's battery life.

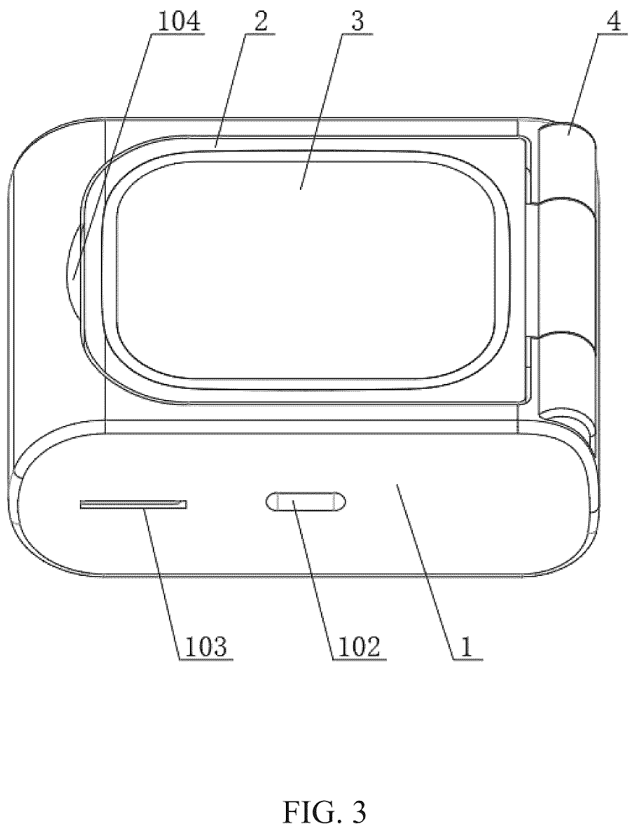

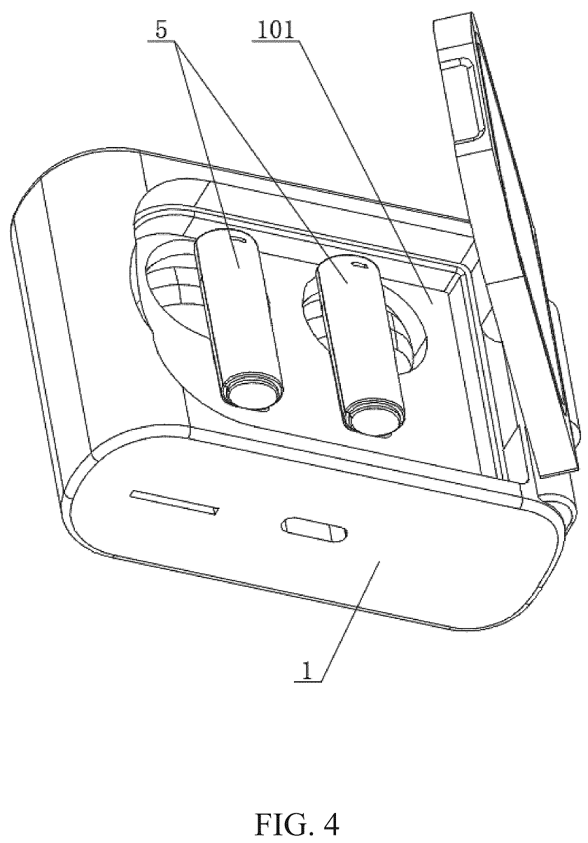

As shown in FIGS. 3, 4 and 6, an earphone placement cavity 101 is arranged in the shell 1, an earphone placement slot is formed at a bottom of the earphone placement cavity 101, and charging pins for charging the Bluetooth earphone 5 are arranged on a bottom wall of the earphone placement slot, where the charging pins are electrically connected to the circuit board and the battery. Charging contacts that match the charging pins are arranged on the Bluetooth earphone 5. An opening is formed at an upper end of the earphone placement cavity 101, and a cover plate 2 is damping hinged at the upper end of the earphone placement cavity 101, so that the cover plate 2 can be opened at any angle without shaking. An embedded groove 201 is formed on an outer end face of the cover plate 2, the display screen 3 is arranged in the embedded groove 201, and the display screen 3 is electrically connected to the circuit board. A fixed hinge shaft seat 4 is arranged on a side of the opening on the upper end of the earphone placement cavity 101, and the cover plate 2 is hinged on the fixed hinge shaft seat 4. A buckle opening structure 104 is arranged on the other side of the opening on the upper end of the earphone placement cavity 101, and a buckle groove is formed at a position of the cover plate 2 corresponding to the buckle opening structure 104. The cover plate 2 can be easily opened through the buckle opening structure 104 and the buckle groove.

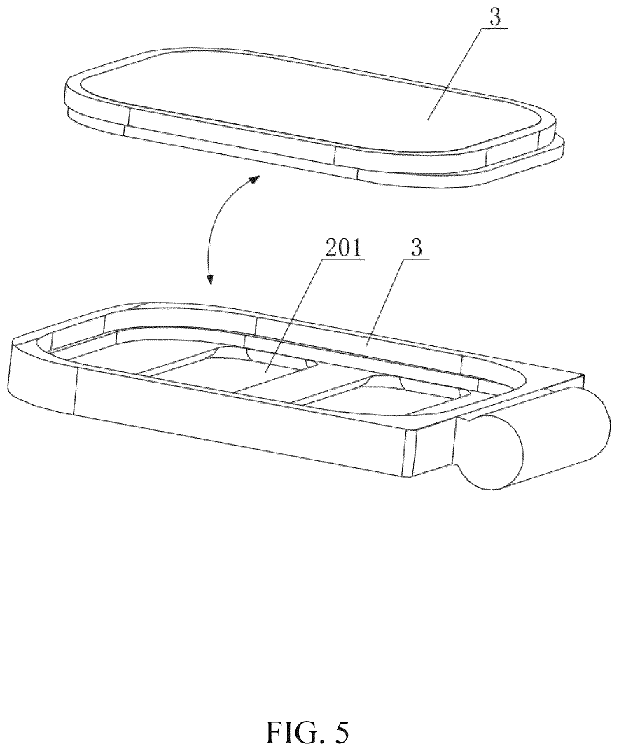

As shown in FIGS. 3, 4 and 5, a first clamping structure is arranged on a wall of the embedded groove 201, a second clamping structure that matches and corresponds to the first clamping structure of the embedded groove 201 in position is arranged on the display screen 3, and the display screen 3 is in clamped connection with the cover plate 2. The first clamping structure and the second clamping structure are a clamping groove structure and a clamping block structure respectively. Alternatively, the first clamping structure and the second clamping structure are a clamping block structure and a clamping groove structure respectively. The display screen 3 is provided with a data communication insertion interface, and a data communication plug electrically connected to the circuit board is arranged in the embedded groove 201. When the display screen 3 is clamped into the embedded groove 201, the data communication plug is inserted into the data communication insertion interface of the display screen 3. A connecting line through which the data communication plug is electrically connected to the circuit board can penetrate through the hollow hinge shaft and the hollow fixed hinge shaft seat 4.

The working principle of the present disclosure: in the present disclosure, the display screen 3 and the camera 6 that are in communication connection with the circuit board are arranged. Pictures, videos, and so on taken by the camera 6 can be viewed through the display screen 3, which facilitates users' understanding of shooting effects in a timely manner, thus enhancing interactivity. Through the display screen 3, a user can accurately know a remaining capacity of the battery, so that the user can charge the battery in a timely manner. The display screen 3 can be a touch screen. Through the display screen 3, the user can perform operations such as file switching, so that human-computer interactions become more efficient. The display screen 3 can be embedded on the cover plate 2 and rotate with the cover plate 2, which effectively enhances the flexibility of the display screen 3, makes the use more convenient, reduces an overall thickness of the earphone cabin, facilitates the design of the internal earphone placement cavity 101, and increases a volume ratio of the battery. A larger-capacity battery can be arranged to effectively prolong the battery life. The cover plate 2 is damping hinged, so that the cover plate 2 and the display screen 3 can be opened at any angle without shaking. Further, the present disclosure is further provided with the microphone and the speaker that are electrically connected to the circuit board. The microphone is capable of acquiring audio signals, so that the present disclosure can be used as a voice recorder, and music playback can be achieved through the speaker. A Bluetooth chip is further arranged on the circuit board, and the circuit board, through the Bluetooth chip, can be in communication connection with an electronic device with a Bluetooth chip, such as a mobile phone, a Bluetooth earphone 5, and the like. After the present disclosure is connected to a mobile phone, the user can view photos or videos taken through a compatible APP. After the present disclosure is connected to the Bluetooth earphone 5, audio playback can be achieved through the Bluetooth earphone 5, which reduces the user's reliance on the mobile phone for audio playback, thereby ensuring the mobile phone's battery life.

To sum up, the present disclosure with a simple structure is compact and portable, and serves multiple purposes, thus effectively enriching usage scenarios.

The above descriptions are only preferred embodiments of the present disclosure and are not intended to limit the present disclosure, and various changes and modifications may be made to the present disclosure by those skilled in the art. Any modifications, equivalent substitutions, improvements, etc. within the spirit and principles of the present disclosure are intended to fall within the scope of protection of the present disclosure.

What is claimed is:

1. A Bluetooth earphone cabin with a camera, comprising a shell, wherein an earphone placement cavity and an electronic element cavity are arranged inside the shell, and a battery and a circuit board that are electrically connected to each other are arranged inside the electronic element cavity; a display screen, a camera and a shutter key are arranged on the shell, wherein the display screen, the camera and the shutter key are all electrically connected to the circuit board; a memory card interface and a memory card reading circuit are arranged on the circuit board, a memory card insertion port leading to the electronic element cavity is arranged on the body wall of the shell, and the memory card insertion port is arranged in a manner of being aligned with the memory card interface on the circuit board.

2. The Bluetooth earphone cabin with a camera according to claim 1, wherein a charging plug is arranged on the circuit board, a charging socket leading to the electronic element cavity is arranged on a body wall of the shell, and the charging plug is located in the charging socket; and an indicator lamp is further arranged on the shell, and the indicator lamp and the camera are located on a same side of the shell.

3. The Bluetooth earphone cabin with a camera according to claim 1, wherein an opening is formed at an upper end of the earphone placement cavity, and a cover plate is damping hinged at the upper end of the earphone placement cavity; an embedded groove is formed on an outer end face of the cover plate, the display screen is arranged in the embedded groove, and the display screen is a touch screen; and an earphone placement slot is formed at a bottom of the earphone placement cavity, and charging pins for charging the Bluetooth earphone are arranged on a bottom wall of the earphone placement slot, wherein the charging pins are electrically connected to the circuit board and the battery.

4. The Bluetooth earphone cabin with a camera according to claim 3, wherein a fixed hinge shaft seat is arranged on a side of the opening on the upper end of the earphone placement cavity, and a buckle opening structure is arranged on the other side of the opening on the upper end of the earphone placement cavity.

5. The Bluetooth earphone cabin with a camera according to claim 3, wherein a first clamping structure is arranged on a wall of the embedded groove, a second clamping structure that matches and corresponds to the first clamping structure of the embedded groove in position is arranged on the display screen, and the display screen is in clamped connection with the cover plate.

6. The Bluetooth earphone cabin with a camera according to claim 5, wherein the first clamping structure and the second clamping structure are a clamping groove structure and a clamping block structure respectively; and alternatively, the first clamping structure and the second clamping structure are a clamping block structure and a clamping groove structure respectively.

7. The Bluetooth earphone cabin with a camera according to claim 5, wherein the display screen is provided with a data communication insertion interface, and a data communication plug electrically connected to the circuit board is arranged in the embedded groove; and when the display screen is clamped into the embedded groove, the data communication plug is inserted into the data communication insertion interface of the display screen.

8. The Bluetooth earphone cabin with a camera according to claim 1, wherein a Bluetooth chip is further arranged on the circuit board, and through the Bluetooth chip, the circuit board is in communication connection with an electronic device with a Bluetooth chip.

9. The Bluetooth earphone cabin with a camera according to claim 1, wherein a microphone is further arranged in the electronic element cavity, wherein the microphone is electrically connected to the circuit board.

10. The Bluetooth earphone cabin with a camera according to claim 1, wherein a speaker is further arranged in the electronic element cavity, an audio decoding chip is arranged on the circuit board, and the speaker is electrically connected to the circuit board through the audio decoding chip.
